(19) United States
(12) Patent Application Publication
(10) Pub. No.: US 2019/0022579 A1
(43) Pub. Date: Jan. 24, 2019

(54) VOC REMOVAL AND DESTRUCTION SYSTEM AND METHOD

(71) Applicant: Harold R. Cowles, Scottsdale, AZ (US)

(72) Inventor: Harold R. Cowles, Scottsdale, AZ (US)

(21) Appl. No.: 16/077,141

(22) PCT Filed: Feb. 13, 2017
(86) PCT No.: PCT/US17/17673

§ 371 Date: Aug. 10, 2018

Related U.S. Application Data
(60) Provisional application No. 62/294,012, filed on Feb. 11, 2016.

(51) Int. Cl. B01D 53/72; B01D 53/83; B01D 53/04

(52) U.S. Cl. CPC B01D 53/72; B01D 53/83; B01D 53/0454; B01D 2259/40081; B01D 2257/708; B01D 2257/90; B01D 2259/4009; B01D 53/0446

(57) ABSTRACT

A system and method for removing volatile organic compounds and airborne odors utilizing an adsorber and a desorber having an adsorbent media circulated there between. Contaminated air is supplied to the adsorber and passed through in contact with the absorbent media; the contaminated media is transported to the desorber and passed through in contact with a stripping gas to remove the contaminants from the media. The cleaned media is returned to the adsorber in a continuous process. The rate of media transfer between the two units and the temperature and volume of the stripping gas provided to the desorber are controlled to maintain the concentration of contaminants in the stripping air to 50% of the lower explosive limit. The system includes a variable speed fan for delivering hot stripping gas in the form of heated ambient air and provides a thermal oxidizer for destroying the VOCs removed from the media.

### RELATED APPLICATIONS

This application is related to and claims priority to a provisional application entitled “VOC REMOVAL AND DESTRUCTION SYSTEM AND METHOD” filed Feb. 11, 2016, and assigned Ser. No. 62/294,012.

### FIELD OF THE INVENTION

This invention relates to methods and apparatus for the collection and destruction of volatile organic compounds and/or control of air born odors.

### BACKGROUND OF THE INVENTION

The removal of Volatile Organic Compounds (VOCs) and airborne odors has been a primary concern in several industries. The environmental and atmospheric parameters required for a non-polluting environment have become even more important in recent years. Additionally, the efficiency of the removal of VOCs and airborne odors has become a critical issue in the maintenance of an economically enforceable healthful environment. The prior art has utilized adsorbent materials including adsorbent beads, to adsorb VOCs from contaminated air stream; see for example issued U.S. Pat. Nos. 5,676,738, 5,904,750 and 6,372,018. These patents describe many of the issues evolving VOC removal and the handling and manipulation of adsorbent materials to accomplish the cleansing of the contaminated air. The present invention is directed to similar subject matter with significant modifications to substantially increase efficiency and reduce the cost of the removal of VOCs and airborne odors from contaminated air.

### SUMMARY OF THE INVENTION

The present invention includes several elements including an adsorber. The adsorber comprises an inlet into which air containing VOCs is introduced, a tray section in which the adsorbent medium, such as carbon, is distributed, and an outlet section to vent the treated air from the top of the adsorber. The adsorption occurs in the tray section, where upon which the adsorbent is suspended. The trays are arranged in a parallel manner, and contain openings or perforations which provide locally high air velocity to suspend the adsorbent above the tray. This mode of operation minimizes the overall pressure drop, allowing for minimized energy use in the process of removing the VOCs from the airstream. This is a significant advantage over prior art fixed packed beds of adsorption medium.

The number of trays required is a function of the inlet concentration of VOCs, and the degree of collection efficiency needed. The overall arrangement, the manner in which the carbon is circulated, and the amount of carbon which is circulated is chosen to allow for a highly efficient counter current removal of VOCs. It also allows for the selective removal of only totally spent, totally saturated adsorbent. The obvious advantage of this is that it provides a means of regeneration of only totally loaded carbon.

A further design advantage is that the adsorber is a continuous process, and does not require temperature cycling as do fixed beds. And, air treated in this type of adsorber can be recirculated back to the source.

The invention also includes a desorber. The desorber component is designed essentially the same as the adsorber. It is smaller scale, and serves the purpose of regenerating the adsorbent (releasing the collected VOCs). The desorber utilizes hot gas to fluidize the VOC laden adsorbent. This higher temperature gas removes the VOCs collected on the adsorbent. The cross section of the adsorber is designed to allow for fluidization at a hot gas flow volume which optimizes the concentration factor of the VOCs. The lowest concentration (percentage) of a gas or vapor in air capable of producing a flash of fire in the presence of an ignition source is defined as the Lower Explosive Limit (LEL). The present invention provides the ability to operate the desorber loop at 50% of the LEL.

VOC laden air, or air with odorous compounds, enters the bottom of the Fluidized Bed (FB) adsorber. The FB adsorber includes three main sections: the inlet diffuser section, the tray section, and the outlet section. The inlet section is intended to collimate and direct the VOC laden air upward. The inlet diffuser is also designed so as to provide a nominal 1.0 inch water column pressure drop. A differential pressure gauge monitors the differential pressure and provides a signal to a Process Logic Controller (PLC) based control system.

The tray section comprises of one or more perforated plate levels, arranged horizontally. Beaded adsorbent is distributed on the tray or trays. The airflow rate is controlled so as to maintain a superficial velocity through the perforations which will both allow at least a minimum fluidization velocity, and at the same time prevent the velocity from exceeding entrainment velocity (the rate at which beaded adsorbent will be carried out of the adsorber). This rate is most easily maintained using the differential pressure signal from the inlet diffuser. This signal is processed in the PLC, which has logic to adjust a variable frequency drive (VFD). The VFD adjusts the process fan speed to maintain the nominal 1.0 inch pressure drop, indicating that the adsorber gas flow rate is within the tolerances mentioned above.

The outlet section collects the cleaned/deodorized air and directs it to outlet stack. Optionally, the cleaned air can be returned to the process area as makeup. This reduces the cost associated with air treatment with the factory or facility. It also, therefore, reduces the overall energy use in the factory and, by extension, the “carbon footprint”.

As the VOC laden air or odor containing air passes through the adsorber, it fluidizes the beaded adsorbent on the tray or trays. This provides excellent mixing of the adsorbent and contact with the air being treated. As this occurs, the VOCs and/or odors transfer from the air stream to the adsorbent beads. The number of trays required to efficiently clear the air is determined using a McCabe-Thiele evaluation. A minimum of 1 tray is needed, but there is no maximum number of trays. The tray arrangement is designed to provide maximum efficiency through counter current removal. That is, as the air passes upward through the trays, it becomes cleaner and cleaner at each successive level of the adsorber. As with all adsorbents, capacity decreases as the concentration of adsorbate decreases. With the FB design described here, however, the adsorbent is cleaner and cleaner from bottom to top. Therefore, VOC or odor will still transfer to the adsorbent as it progresses up through the trays. Clean air leaves the top tray and is directed out of the adsorber.

With the equipment and operation described above, the adsorber is maximally utilized. As the adsorber falls from the bottom tray, it is fully saturated. This is a significant advantage in that the system will finally treat only totally spent and loaded adsorbent material. The adsorbent, thus fully utilized, collects in the adsorber bottom hopper. From there, it is transferred to the top of the fluid bed desorber.

The fluid bed desorber has three main sections: the inlet section, the tray section, and the outlet section. Hot desorption gas enters the inlet section and is directed upward into the tray section. The hot gas is intended to both provide the energy needed to strip the VOCs/odor materials from the adsorbent, and to fluidize the adsorbent on the perforated plate sieve trays.

The tray section contains one or more parallel perforated sieve trays. The adsorbent to be regenerated is distributed on these trays. The hot gas flow rate is adjusted to provide at least a minimum fluidization velocity, but to limit the maximum so as to be less than entrainment velocity. In the case of the desorber, this can be adjusted manually at the time of initial startup. Or, as with the adsorber, it can incorporate a differential pressure sensor. This sensor would provide a signal to the PLC. Logic in the PLC would then use that signal to adjust a VFD to maintain a fan speed which provides the necessary hot gas flow.

The outlet section collects the hot desorbate gas, laden with the concentrated VOC or odor compound stripped from the carbon. This concentrated stream is directed to a contaminant removal or destruction device, typically a thermal oxidizer (TO). Alternatively, the concentrated desorbate stream can be directed to a boiler or other energy producing hardware. It is also possible to direct the concentrated VOC/odor stream to a condenser or other collection system, such as a fixed adsorbent system.

The fluid bed desorber can provide the maximum allowable concentration during the desorption/regeneration process. The limit is 25% of the lower explosive limit (LEL); however, with the LEL monitoring device of the present system, the limit is 50% of the LEL. To design to these limits requires a thorough analysis of process conditions and flow rates. As an example: if the process contains VOC loading at 100 parts per million by volume (ppmv; a typical description for VOC loading), and 50% of the LEL is 5,000 ppmv, then the system can be designed to provide a concentration ratio of 50:1. This means that if the process exhaust stream is, for example, 100,000 standard cubic feet per minute (scfm), then the desorbate volume can be as low as 2,000 scfm—using an LEL monitor. This significant reduction in final volume to be treated, with an equivalent increase in concentration, provides the most economical treatment process available. Moreover, the greatly reduced energy needed directly translates to lower emission rates of NOx, CO2, and other air contaminants—both at the user's facility and the power plant from which electricity is provided. It is also possible to utilize the energy derived from the concentrated VOCs to offset other energy uses.

The overall desorption process involves a “hot gas loop”. It contains the hot gas fan, a heat exchanger, conveying ductwork, the LEL monitor, and either a heat exchanger, or a hot gas blending section. The hot gas fan is used to convey the hot desorption gas through the desorber, and the desorbate stream to the destruction device, or other treatment device. The fan uses a VFD, the operation of which is governed by the PLC control logic.

The heat exchanger is used to provide the hot stripping gas for desorption/regeneration of the adsorbent beads. The heat exchanger uses the energy derived from the VOC destruction process to provide hot gas for desorption. This arrangement draws air through and proportionally around the heat exchanger to provide the exact temperature and volume of stripping air needed. A thermocouple at the discharge of the hot gas fan provides a signal to the PLC. This signal is the basis for control of the temperature and flow loop. The PLC logic uses this signal to modulate a damper which proportions air through and around the heat exchanger so as to maintain the set point temperature of the stripping gas.

As an alternative, the hot stripping gas can be derived from the thermal destruction device flue gas directly. In this case, a blending device replaces the heat exchanger. With this option, a fixed amount of hot gas is pulled from the thermal oxidizer exhaust and blended with cooling air. The cooling air flow is regulated using a modulating damper to blend it with the oxidizer exhaust gas.

The LEL monitor is a part of the hot gas control loop. This allows for the maximum concentration ratio of the VOCs collected, and therefore the optimum operation of the system. The LEL monitor is positioned in the hot gas loop just prior to the point at which the desorbate duct section entering the thermal destruction device. The LEL monitor continuously transmits “Percent LEL” data to the PLC in the control panel. The PLC can be programmed to respond to a “High LEL’ signal in two ways. On the one hand, the PLC will direct the system to stop the flow of spent adsorbent from the adsorber to the desorber. This adsorbent flow stoppage continues until the LEL level indication is less than 50%. At this point, flow is resumed. On the other hand, the PLC can direct the hot gas fan VFD to increase the fan speed. This reduces the LEL reading by increasing the hot gas volume. In the latter case, the overall operational economics can be achieved. Alternatively, the hot gas fan—VFD—LEL monitor combination can be programmed to always operate at 50% of the LEL by modulating the hot gas fan speed up or down as a function of the LEL. In this case, the fan speed would be increased under high LEL conditions (50%), and reduced when LEL is below, say, 45% of the LEL. This mode represents the absolute best case in terms of minimized energy use and secondary gas emissions.

One embodiment of the current invention utilizes a Thermal Oxidizer (TO) for final treatment/destruction. The TO is designed to accommodate the reduced volume/increased concentration desorbate stream. The burner and control logic are intended to provide optimized energy efficiency and minimized secondary air contaminants, such as CO2 and NOx. The burner component of the TO is selected to provide enough energy to increase the TO from ambient temperature to operating temperature (typically about 1400 F). Ideally, the burner should be of a design which allows for a very low “minimum fire” rate, or essentially pilot operation. Using this type of burner, the TO will consume negligible fuel at peak desorbate fuel concentration. The best case combination of desorber and oxidizer design and control will provide a steady source of concentrated VOC such that no make up fuel will be needed for the TO—or even potentially result in surplus energy for other uses. An additional optional burner would be the so called “Low NOx” design, which reduces the production of NO and NO2 (oxides of nitrogen).

The integrated burner/control sub-system operates as follows. At “cold start”, the PLC logic commands the burner to operate at its full firing rate (maximum heat output). Typically, this phase of operation will also include the simultaneous operation of the hot gas fan, to bring the TO and hot gas loop up to normal operating temperature before desorption of beaded adsorbent is initiated. As such, no adsorbent will be conveyed to the desorber during this heat up stage.

When the hot gas loop and TO have reached set point operating conditions, the PLC logic commands the system to begin adsorbent transfer to the desorber. When this occurs, the desorbate gas stream will immediately begin to convey concentrated VOCs to the TO.

As the VOC feed from the desorber to the TO increases, the TO temperature will increase as a result of the energy content of the VOCs. As this occurs, the PLC logic will direct the burner to reduce its heat output to maintain the temperature set point of the TO. This will continue until the burner reaches minimum fire, or “pilot” operation.

When using a TO, there is a thermocouple in the combustion chamber which provides temperature data for system PLC. The PLC uses this data to control the burner firing. The PLC will modulate the burner and combustion blower to maintain the TO operating temperature set point as VOC feed rate varies. There may be applications for which the VOC heat value is high enough such that the TO temperature continues to increase even at minimum firing rate of the burner. In this case, an optional “cooling air” fan can be included with the TO. This fan would be modulated so as to provide cooling air directly to the combustion chamber if the temperature cannot be controlled through burner modulation only. In this case; the operation would be as follows:

(a) Operation of the TO burner and hot has loop is initiated at startup;

(b) When the hot gas loop and TO reach operating temperature, absorbent flow to the desorber is initiated. This begins the flow of concentrated VOCs to the TO;

(c) As VOCs reach the TO, their fuel value will begin to increase the TO temperature. As this occurs, the PLC will drive the burner to a lower firing rate. This will normally restore the TO to its set point temperature; and

(d) If the TO temperature increases beyond a preset “High Temperature” set point, then the cooling air fan will turn on and provide cold air to the TO chamber. This should bring the TO temperature back to set point. This fan can be fitted with a modulating damper if more precise control is needed. Optionally, the combustion air fan for the burner can be oversized, with the surplus air being modulated to the TO combustion chamber for cooling as needed. When not needed, the excess air can be directed to atmosphere.

Another embodiment of the invention would incorporate a TO burner which can be operated at fuel-to-air ratios that are below, equal to, or above the stoichiometric ratio. That is, the burner can operate with less reaction fuel than the oxygen needed for complete combustion, at exactly the amount of air and fuel to use all fuel and oxygen reactants, or more fuel than can be oxidized by the oxygen available.

(a) The preferred configuration and operation in this case would be to provide exactly stoichiometric air and fuel. The advantage in this case would be that the flue gas would be free of oxygen. This would eliminate safety issues and allow the overall system to operate at any concentration factor and not be limited by 50% of the LEL. Another advantage here is that reactions between oxygen and VOCs, which can foul the adsorbent active sites, are prevented; and

(b) Another variation would be to operate the burner at up to 5% oxygen by volume. Combustion and explosions cannot occur at this oxygen level. However, there may still be reactions between oxygen and concentrated solvents.

While the system described herein relates to a Volatile Organic Compound (VOC) and/or odor abatement, the system provides equipment and control logic which allows for the minimized Greenhouse Gas (GHG) and other pollutants, and minimizes energy consumption arising as a consequence of said abatement. It is consistent with addressing current concerns about such secondary pollutants arising from a primary treatment device, and the contribution of these pollutants to global warming. A significant secondary novel aspect and benefit is the fact that the present invention allows for the use of substantially any spherical adsorption medium in a single equipment design. These features allow for optimal system performance regardless of the type of VOCs or odors to be treated by simply substituting different types of adsorbent in the same equipment.

### BRIEF DESCRIPTION OF THE DRAWINGS

The present invention may more readily be described by reference to the accompanying drawings in which:

FIG. 1 is a process flow diagram of a VOC removal and destruction system incorporating the teachings of the present invention.

FIG. 2 is a functional flow diagram showing gas and signal flow for a system incorporating the teachings of the present invention.

FIG. 3 is a process and functional flow diagram combining the features shown separately in FIGS. 1 and 2.

### DETAILED DESCRIPTION OF THE INVENTION

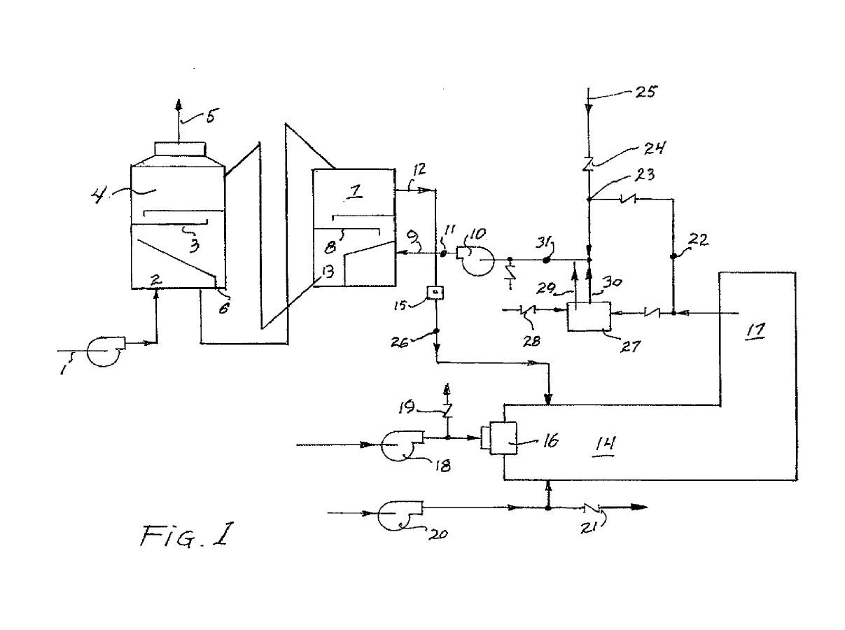

Referring to FIG. 1, a contaminated air stream such as process exhaust air, VOC laden air, or air with odor components 1 enters the fluidized bed (FB) adsorber vessel 4 inlet section 2. The inlet section is intended to collimate and direct the VOC laden air upward. The inlet provides a nominal 1.0 inch water column pressure drop. This pressure drop may vary from 0.1 inches of water column to 5.0 inches of water column, depending on process conditions of the treated gas. A differential pressure gauge monitors the differential pressure and provides a signal to the PLC based control system. The air is directed upward into the tray section 3. The upward passage of VOC laden air is controlled to fluidize the adsorbent beads distributed on the trays. The tray section consists of one or more perforated plate levels, arranged horizontally. Hole sizes in the perforated tray can range from 1.0 mm to 10.0 mm, depending on the type of adsorption medium being used. The spacing between holes can range from 2 mm center to center, to as much as 25 mm center to center, again depending on the type of beaded adsorbent used. Any one of several types of beaded adsorbent is distributed on the tray or trays. The beaded adsorbent can be natural source activated carbon, synthetic organic material based activated carbon, polymeric material, pyrolytic synthetic material, zeolite of various types, silica, or a combination of one or more of these materials. The equipment will function with any type of beaded material with adsorptive properties. The apparent density of said beads can range from 0.1 grams per cubic centimeter to over 5 grams per cubic centimeter. The airflow rate is controlled so as to maintain a superficial velocity through the perforations which will both allow at least a minimum fluidization velocity, and at the same time prevent the velocity from exceeding entrainment velocity (the rate at which beaded adsorbent will be carried out of the adsorber). The velocity can range from a low of 50 linear feet per minute to a high of 500 feet per minute, depending on the type of adsorbent beads being used in the equipment. The rate is maintained using the differential pressure signal from the inlet. This signal is processed in the PLC, which has logic to adjust a variable frequency drive to adjust the process fan speed so as to maintain the nominal 1.0 inch pressure drop, indicating that the adsorber gas flow rate is within the tolerances mentioned above. The total mixing and contact of the air and beads results in transfer of VOCs from the air to the beads, otherwise known as “adsorption”. Clean air exits the adsorber outlet 5. Spent adsorbent beads collect in the bottom hopper 6 of the adsorber. The outlet section collects the cleaned/deodorized air and directs it to outlet stack. Optionally, the cleaned air can be returned to the process area as makeup. This reduces the cost associated with air treatment with the factory or facility. It also, therefore, reduces the overall energy use in the factory and, by extension, the “carbon footprint”. As the VOC laden air or odor containing air passes through the adsorber, it fluidizes the beaded adsorbent on the tray or trays. This provides excellent mixing of the adsorbent and contact with the air being treated. As this occurs, the VOCs and/or odors transfer from the air stream to the adsorbent beads. The number of trays required to efficiently clear the air is determined using a McCabe-Thiele evaluation. A minimum of 1 tray is needed, but there is no maximum number of trays. The tray arrangement is designed to provide maximum efficiency through counter current removal. That is, as the air passes upward through the trays, it becomes cleaner and cleaner at each successive level of the adsorber. As with all adsorbents, capacity decreases as the concentration of adsorbate decreases. With the FB design described here, however, the adsorbent is cleaner and cleaner from bottom to top. Therefore, VOC or odor will still transfer to the adsorbent as it progresses up through the trays. Clean air leaves the top tray and is directed out of the adsorber. With the equipment and operation just described, the adsorbent is maximally utilized. As it falls from the bottom tray, it is fully saturated. This is a significant advantage in that the system will finally treat only totally spent and loaded adsorbent material. The adsorbent, thus fully utilized, collects in the adsorber bottom hopper 6. From there, it is transferred to the top of the fluid bed desorber 7. Alternatively, the adsorber can be placed over the desorber such that the spent medium will gravity feed directly to the top of the desorber. Additionally, the perforated trays can be configured as a screen, or combined with a screen, such that the beaded medium is always held up on the trays, even with no process flow. In the case of that embodiment, the spent medium will be transferred by air or gravity to the top tray of the desorber. The desorber can also be thus configured.

Spent adsorbent beads from adsorber hopper 6 are transferred to the top of desorber 7. Hot desorption gas enters the inlet section and is directed upward into the tray section. The hot gas is intended to both provide the energy needed to strip the VOCs/odor materials from the adsorbent, and to fluidize the adsorbent on the perforated plate sieve trays. The beads move downward through tray section 8. Simultaneously, clean hot stripping air 9 is introduced to the bottom of the desorber and flows upward through the trays. The hot stripping gas temperature can be as low as 100 F, to as high as 700 F. The set point temperature will depend on the type of adsorbent beads used, and on the type of volatile organic compounds being treated. The stripping gas is conveyed using hot gas fan 10. The hot gas temperature is monitored by thermocouple 11 at the discharge of hot gas fan 10. The signal from thermocouple 11 is transmitted to the PLC of the main control system. The hot gas flow into the desorber is controlled to fluidize the beads on the desorber trays. The tray section contains one or more parallel perforated sieve trays. The desorber tray design is based on the same design considerations and features as described for the adsorber trays, above. The adsorbent to be regenerated is distributed on these trays. The hot gas flow rate is adjusted to provide at least a minimum fluidization velocity, but to limit the maximum so as to be less than entrainment velocity. In the case of the desorber, this can be adjusted manually at the time of initial startup. Or, as with the adsorber, it can incorporate a differential pressure sensor base on the same design and operational considerations as described for the adsorber, above. This sensor would provide a signal to the PLC. Logic in the PLC would then use that signal to adjust a VFD to maintain a fan speed which provides the necessary hot gas flow. This provides total mixing of hot gas with spent adsorbent beads, an action which forces the adsorbed VOCs to be released into the hot gas stream. The desorbate stream with highly concentrated VOCs exits the desorber through duct 12. The cleaned/desorbed beads collect in desorber bottom hopper 13. From 13, the cleaned adsorbent is transferred back to the top of the adsorber for reuse. While the transfer of adsorbent between that adsorber and desorber, and back, can be either intermittent or continuous, the preferred mode of operation is continuous.

The fluid bed desorber provides the maximum allowable concentration during the desorption/regeneration process. The limit is 25% of the lower explosive limit (LEL) without monitoring, or 50% of the LEL with an LEL monitoring device. To design to these limits requires a thorough analysis of process conditions and flow rates. As an example: if the process contains VOC loading at 100 parts per million by volume (ppmv; a typical description for VOC loading), and 50% of the LEL is 5,000 ppmv, then the system can be designed to provide a concentration ratio of 50:1. This means that if the process exhaust stream is, for example, 100,000 standard cubic feet per minute (scfm), then the desorbate volume can be as low as 2,000 scfm—using an LEL monitor. This significant reduction in final volume to be treated, with an equivalent increase in concentration, provides the most economical treatment process available. Moreover, the greatly reduced energy needed directly translates to lower emission rates of NOx, CO2, and other air contaminants—both at the user's facility and the power plant from which electricity is provided. It is also possible to utilize the energy derived from the concentrated VOCs to offset other energy uses

The highly concentrated VOCs or odorous materials are conveyed from the desorber to the thermal oxidizer (TO) 14 via duct 12. At the same time, LEL monitor 15 continuously analyzes the concentrated VOC stream on a real time basis. Data is transmitted from the LEL monitor to the main PLC for interpretation and use in system control. If the LEL signal indicates a VOC reading which is 50% of the LEL, the PLC system will initiate process controls which will either slow or stop the flow of beads to the top of the desorber 7, or increase the speed of hot gas fan 10. The result of either of these actions will be a reduction of the VOC concentration in duct 12 to a point below 50% of the LEL. Once this is achieved, the PLC will govern return to normal operation. In the most efficient mode, the PLC will use the LEL data to fine tune the hot gas fan to keep the overall VOC concentration to the TO at a level just below or at 50% of the LEL.

The concentrated desorbate stream is introduced to TO 14 either through the body of burner 16, or directly into the discharge flame of the burner. This mode of introduction optimizes the oxidation process efficiency via the immediate mixing of the VOC stream with the burner hot gas. This is a result of minimizing any dilution effect that would occur if the concentrated streams were discharged into the main chamber of the TO 14. Several “nozzle mix” or “premix” approaches can be used in the current invention.

A thermocouple (T/C) 17 continuously monitors the temperature of the combustion chamber of TO 14. The T/C transmits data to the main system PLC. As the fuel value of the concentrated VOCs begin to raise the temperature of the TO, the PLC will act to reduce the firing rate of burner 16. This will reduce the heat contribution from the burner, and thereby maintain the normal operating temperature of the TO chamber. In some cases, there may be enough variation in the heat value of the concentrated VOCs such that additional cooling air is needed to maintain the TO chamber temperature at a safe and practical level. There are two alternative embodiments to accomplish this. In the first case, combustion blower 18 can be oversized, so that there will be excess air available for cooling if needed. This is the preferred embodiment, since it is mechanically simpler. In this case operation would be as follows:

(a) The signal from T/C 17 shows that the TO chamber is continuing to rise past the “high” level, for example 1500 F, despite the burner being at minimum fire rate. The PLC will initiate the addition of cooling air by modulating bypass damper 19 so as to redirect air from bypass to atmosphere, and into the TO chamber. The PLC will modulate the bypass damper until the temperature comes back under control, 1400 F for example. If the VOC heat value falls back to normal, the PLC will fully redirect cooling air to bypass; and

(b) The second embodiment is to have a separate dedicated cooling air fan 20 to maintain the TO chamber at a safe temperature. In this case, the dedicated fan is idle unless needed. If the PLC deter mines that cooling air is needed, the fan will be energized and modulated using valve 21. The mode of operation is then the same as with the single oversized combustion air fan.

The hot gas 9 for desorption is derived from the energy of oxidation of the VOCs. Specifically, a portion of the hot gas from oxidation in TO 14 is drawn from the TO chamber. The volume of raw hot gas is controlled using a restrictor orifice (RO) 22. This RO provides the amount of air needed at the negative pressure value resulting from normal operation of hot gas fan 10. To provide the full volume of stripping hot gas needed, at the temperature needed, cooling air is blended with the raw hot gas. Cooling air is brought into a blending “T” 23, through a cooling air valve 24. While the cooling air source can be ambient air 25, there can be large variations in the air temperature (in some areas of the world perhaps as much as 100 F difference between summer and winter). This condition may result in difficulty maintaining optimum operation in terms of hot gas flow and volume. It is therefore a preferred embodiment to use a small amount of either process air 1 entering adsorber, or cleaned air 5 exiting the adsorber. This source of cooling air will be much more stable, as a rule, than ambient air.

At the time of initial commissioning of equipment, the RO 22, and the cooling air valve 24 are manually adjusted to provide the volume and temperature of hot gas needed for proper operation of the desorber. Thereafter, this process is automatic. In automatic mode, TC 11 continuously monitors the hot gas temperature 9. The TIC signal is transmitted to the main system PLC. The PLC will cause the system to maintain proper temperature by modulating cooling air valve 24. If the hot gas temperature needs to increase beyond the range of the modulation capability of the damper, manual intervention to readjust RO 22 may be needed. Thereafter, automated operation under PLC control can be restored. For safety reasons, a thermocouple 26 monitors the desorber outlet temperature. If the outlet temperature exceeds the inlet under normal operation, the PLC will stop the hot gas flow.

As an alternative to blending flue gas to provide hot gas 9, a heat exchanger 27 can be used. There are 2 options in terms of the use of the heat exchanger. In the first option, a portion of hot flue gas passes on the outside of the heat exchanger elements, as cooling air is pumped over the inside surfaces. In this way, only hot air 29 having no flue gas constituents is introduced to the desorber. The hot gas temperature is controlled using the signal from TC 11 to the PLC to modulate valve 28. In the second case, the reverse mode of operation is used. That is, hot flue gas is on the inside conveyances of the heat exchanger, and ambient cooling air is passed over the outside to cool the flue gas. The same TC and PLC combination, and operational philosophy, are used to control temperature. This latter case is necessary if the layout is based on stoichiometric operation of the TO, so as to provide reduced oxygen or oxygen free hot gas 30 for stripping/desorbing. In this case, an oxygen analyzer 31 is used. It samples the hot stripping gas just before it enters the desorber. The oxygen analyzer continuously transmits a “percent oxygen” signal to the main PLC. The PLC adjusts the burner and blower as need be, to maintain the O2 level in the flue gas at the desired level.

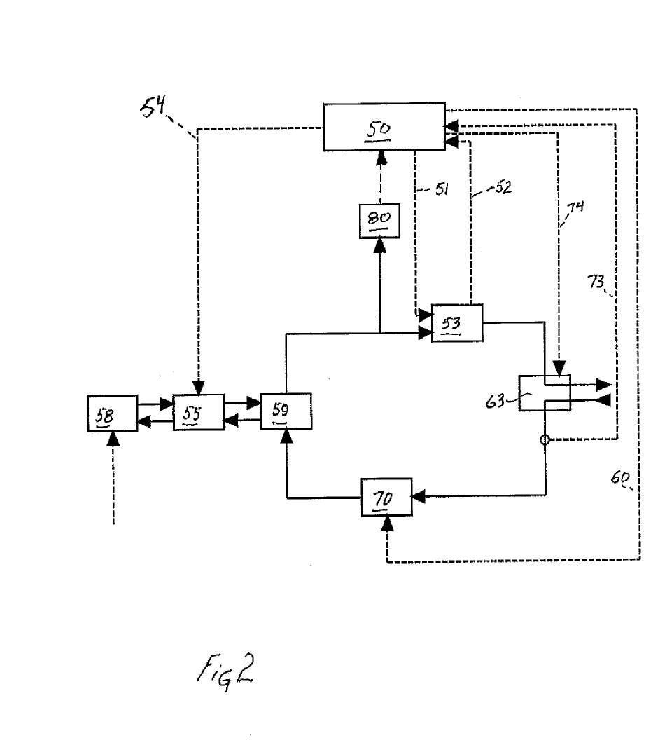

The operation and system of the present invention may more readily be described by reference to a functional flow diagram showing gas and signal flow for a system incorporating the present invention. Referring to FIG. 2, upon starting operation, the Process Logic Controller 50 (PLC) starts the thermal oxidizer 53 (TO). The TO provides a temperature signal 52 to the PLC. Using this signal 52, the PLC sends control signal 51 to adjust the TO to the desired set point.

When the TO is ready, the PLC signals 54 the adsorbent transfer system 55. Adsorption media moves between Adsorber 58 and Desorber 59. The PLC directs 60 the energization of the hot gas fan 70. The hot gas fan draws air through a heat exchanger 63, which is indirectly heated by the TO flue gas. A temperature signal 73 is sent from the exchanger outlet to the PLC. The PLC through signal 74 adjusts the heat exchanger 63 to maintain the desired hot gas temperature. Optionally, a blending “T” can be used to supply the hot gas, by combining TO flue gas and outside cooling air.

A Lower Explosive Limit (LEL) monitor 80 continuously tests the desorber outlet gas, to determine the percent of LEL and communicates this data to the PLC. The PLC uses this data to optimize the overall system energy efficiency, and minimize fuel use. This also provides the lowest possible secondary pollutants, such as greenhouse gases, NOₓ, etc. This is accomplished through controlling stripping gas volume, carbon transfer rate, or a combination of both. The fuel value of the desorbate is often enough to sustain the TO, and also provide a means of recovering energy from pollutants which otherwise be vented to atmosphere.

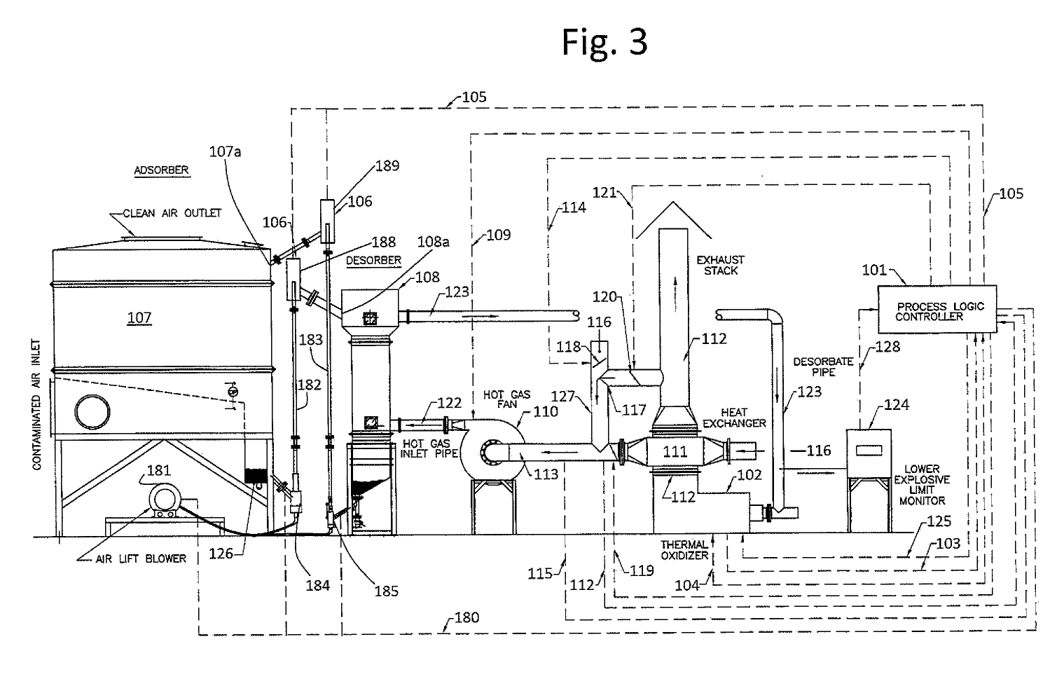

FIG. 3 is a process and functional flow diagram combining the features shown separately in FIGS. 1 and 2. Start up of the equipment begins with signal 125 from the process logic controller (PLC) 101, to the thermal oxidizer (TO) 102, to initiate operation. The TO 102 provides a temperature signal 103 as feedback to the PLC 101. The PLC 101 uses this temperature signal 103 to control the TO 102 ramp up to the desired set point, via PLC 100 output 104.

When the TO 102 reaches the desired temperature setting, the PLC 101 sends a signal 105 the media transport system (MTS) 106 to begin operation. At this point, the flow of beaded adsorption medium (BAM) 126 commences from the adsorber 107 to the desorber input 108a, and from the desorber 108 back to the adsorber input 107a. The air flow rate in the MTS is controlled to maintain a superficial velocity through the perforations in the trays of the vessel 107 and 108 to provide a minimum fluidization velocity. The velocity can range from a low of 50 linear feet per minute to a high of 500 feet per minute, depending on the type of adsorbent beads being used in the equipment.

The media transfer system includes an airlift blower 181 that supplies a transporting airflow to media transfer pipes 182 and 183. Air from the blower is introduced to the bottom of transfer nozzles 184 and 185, respectively, which receive media from the vessels 107 and 108, respectively, and transport the media upwardly to corresponding media separators 188 and 189, respectively. The respective separators at the top of the corresponding pipes permit the media to become disengaged with the airstream and follow by gravity into the top of the adsorber or desorber vessel. As transfer air from the airlift blower 181 is introduced to the bottom of the transfer nozzle 184 on the adsorber vessel, it will entrain media that has been gravity fed to the nozzle and carried up the vertical transfer pipe into the media separator 188. In the separator, which comprises an expansion chamber, the transfer air slows sufficiently to disengage the media. The media then falls to the bottom of the separator and drains by gravity onto the top tray of the adsorb vessel. Similarly, the media from the desorber is transported through the transfer pipe 183 to the separator 189. The media in the respective separators falls to the bottom of the corresponding separator and drains by gravity into the tray of the adsorber and desorber vessels. The media transfer rate is controlled by using adjustable media control orifices in the corresponding feed pipe 190, 191 connecting the media from the corresponding vessel to the transfer nozzle, or by providing an adjustable gap in the nozzle itself.

At the same time that the PLC 101 initiates MTS 106, PLC 101 also sends signal 109 to the hot gas fan 110 to begin operation. The hot gas fan 110 draws ambient air 116 through heat exchanger 111. The heat exchanger 111 provides the energy to raise the ambient air to the desired set point temperature, by indirect heating from flue gas 112. The hot desorption gas 113 temperature which results from this operation is controlled by PLC signal 114. Feedback signal 115 from the hot desorption gas duct provides data to PLC 101, which is used to maintain set point by adjusting ambient airflow balance through and around heat exchanger 111. Optionally, a blending “T” 117 can be used to provide the hot desorption gas 113. In this case, the hot gas fan 110 draws a combination of flue gas 112 and ambient air 116 into “T” 117, giving rise to an alternate source of hot desorption gas 113 in duct 127. PLC 101 receives temperature hot desorption gas temperature signal 115, and uses signal 115 to adjust the positions of ambient air intake damper 118, via PLC signal 119, and flue gas intake damper 120, via signal 121. In this way, PLC 101 controls the positioning of these dampers such that the resulting combination of flows gives rise a hot desorption gas 113 which is carefully and precisely maintained at the desired set point temperature.

The hot desorption gas 113, whether arising from heat exchanger 111, blending “T” 117, or a combination of both sources, is conveyed to the bottom of desorber 108, via hot gas fan 110, and through duct 122. As hot desorption gas 113 flows upward through the desorber 108, it passes through downward moving BAM 26, which is conveyed into desorber 108 by MTS 106, at a set rate. The upward mass flow rate of hot desorption gas 113 through desorber 108, and the energy content of hot desorption gas 113, are sufficient to simultaneously suspend the BAM 126 as a fluidized bed, and to raise the temperature of the BAM 126 to the desorber 108 operating set point temperature. These factors will result in the release of adsorbed volatile organic compounds (VOCs), and/or odorous compounds, which were collected on the BAM 126 in Adsorber 107. In this way, the adsorbed VOCs and/or odorous compounds will transfer from the BAM 126, into the hot gas stream 113, resulting in a highly concentrated desorbate gas stream 123. The magnitude of concentration is a function of the relative proportions of the volume of contaminated air treated by adsorber 107, and the much smaller hot desorption gas 113 volume conveyed to desorber 108 to release the VOCs and/or odorous compounds from BAM 126.

Concentrated desorbate gas stream 123 is conveyed to the TO 102. In TO 102, the volatile materials which are contained in desorbate gas stream 122 are completely destroyed by the process of thermal oxidation at elevated temperature. Completely “clean” flue gas 112 leaves TO 102. The content of the concentrated VOCs and/or odorous materials in Desorbate Gas Stream 123 are continuously monitored by lower explosive limit (LEL) monitor 124. LEL monitor 124 provides real time VOC, and/or odorous material concentration data continuously, which PLC 101 uses to both optimize system operational efficiency, and to maintain the concentration of VOCs and/or odorous materials in the desorbate gas stream 123 so that the value is at or near the mandatory maximum level or 50% of the lower explosive limit (LEL) at all times. LEL monitor 124 provides a continuous “percent of LEL” signal 128 to PLC 101. PLC 101 uses LEL signal 128 to make adjustments to MTS 106 which will result in variations in the BAM 126 mass flow rate to Desorber 108. This, in turn, regulates the amount of VOC and/or odorous material contained in desorbate gas stream 123, in a precisely controllable manner. In this way, the overall control and equipment package, in conjunction with the dedicated control logic, can give rise to and maintain a desorbate gas stream 123 which is always at or near the 50% LEL limit for the VOCs and/or odorous compounds, to TO 102. This allows for the design of a VOC abatement and/or odor control device with the highest achievable efficiency, both with regard to minimized energy and fuel consumption, and minimized secondary “greenhouse gases” and other gaseous pollutants. The variation in feed rates permits the utilization of any type of adsorption medium. This will allow for the use of any spherical adsorbent material including but not limited to natural sourced activated carbon, synthetic polymeric beaded materials, pyrolytic variations of synthetic polymeric beads, beaded zeolites of all types, silica beads, and any combination of these materials. The control of the media transfer thus permits the selection of a variety of adsorbent materials that may vary in density and diameter of the spherical adsorbent material. All energy required to provide hot desorption gas 113 is derived from flue gas 112, using heat exchanger 111. And because the TO 102 gives rise to surplus heat, beyond that which is needed to provide hot desorption gas 113, the surplus energy can be recovered from the VOC abatement process for other uses, reducing the need for other sources of energy for any given purpose.

What is claimed:

1. A process for removing volatile organic compounds (VOCs) and air born odors from a contaminated airstream comprising the steps of:
(a) providing an adsorber vessel having a contaminated air inlet and a clean air outlet defining therebetween a generally upward directed air flow path through the adsorber vessel, and an adsorbent media input and an adsorbent media output defining therebetween a generally downward directed media flow path, said media flow path arranged generally counter to the generally upward directed air flow path;
(b) providing a desorber vessel having an adsorbent media inlet and an adsorbent media outlet defining a generally downward media path therebetween and a desorbate gas inlet and a desorbate gas outlet defining therebetween a generally upward directed desorbate gas flow path, said desorbate gas flow path arranged generally counter to the downward directed media path;
(c) providing a first media transfer supplying the media inlet of the adsorber from an outlet of desorber;
(d) providing a second media transfer supplying the media input of the desorber from the outlet of the adsorber;
(e) the media transfer between the adsorber and desorber set at a predetermined transfer rate;
(f) directing the contaminated airstream into the contaminated air inlet of the adsorber;
(g) adsorbing the volatile organic compounds and odor causing compounds to the media in the adsorber media flow path;
(h) transferring the media from the adsorber to the desorber and placing the media and volatile organic compounds and odor causing compounds in a desorbate gas flow path;
(i) directing the desorbate gas from the desorbate gas outlet to a contaminant destruction system to remove contaminants from the desorbate gas;
(j) monitoring the concentration of VOCs or odor compounds in the desorbate gas from the desorbate gas outlet; and
(k) adjusting the first media transfer supplying the media inlet of the adsorber and adjusting the second media transfer supplying the media inlet of the desorber to modify the predetermined transfer rate and adjust the concentration in the desorbate gas to 50% of the lower explosive limit.

2. The process of claim 1 wherein the desorbate gas from the desorbate gas outlet is directed to a thermal oxidizer to destroy VOCs or odor compounds in the desorbate gas.

3. The process of claim 2 wherein the desorbate gas from the desorbate gas outlet is directed to a thermal oxidizer to destroy VOCs or odor compounds in the desorbate gas, and wherein flue gas from the thermal oxidizer is supplied to a heat exchanger for indirect heating of ambient air and supplying the heated ambient air to the desorber.

4. The process of claim 2 wherein the desorbate gas from the desorbate gas outlet is directed to a thermal oxidizer to destroy VOCs or odor compounds in the desorbate gas, and wherein flue gas from the thermal oxidizer is combined with ambient air and supplied to the desorbate gas inlet of the desorber.

5. A process for removing volatile organic compounds and air born odors from a contaminated airstream comprising the steps of:
(a) providing an adsorber vessel having a contaminated air inlet and a clean air outlet defining therebetween a generally upward directed air flow path through the adsorber vessel, and an adsorbent media input and an adsorbent media output defining therebetween a generally downward directed media flow path, said media flow path arranged generally counter to the generally upward directed air flow path;
(b) providing a desorber vessel having an adsorbent media inlet and an adsorbent media outlet defining a generally downward media path therebetween and a desorbate gas inlet and a desorbate gas outlet defining therebetween a generally upward directed desorbate gas flow path, said desorbate gas flow path arranged generally counter to the downward directed media path;
(c) providing a first media transfer supplying the media inlet of the adsorber from an outlet of desorber;
(d) providing a second media transfer supplying the media input of the desorber from the outlet of the adsorber;
(e) the media transfer between the adsorber and desorber set at a predetermined transfer rate;
(f) directing the contaminated airstream into the contaminated air inlet of the adsorber;
(g) adsorbing the volatile organic compounds and odor causing compounds to the media in the adsorber media flow path;
(h) transferring the media from the adsorber to the desorber and placing the media and volatile organic compounds and odor causing compounds in a desorbate gas flow path;
(i) directing the desorbate gas from the desorbate gas outlet to a contaminant destruction system to remove contaminants from the desorbate gas;
(j) monitoring the concentration of VOCs or odor compounds in the desorbate gas from the desorbate gas outlet;
(k) heating ambient air and supplying the heated ambient air to the desorbate gas inlet of the desorber; and
(l) modifying the volume and temperature of the heated ambient air delivered to the desorber to adjust the concentration of VOCs or odor compounds in the desorbate gas at the desorbate gas outlet to 50% of the lower explosive limit.

6. The process of claim 5 including the step of adjusting the first media transfer supplying the media inlet of the adsorber and the second media transfer supplying the media inlet of the desorber to modify the predetermined transfer rate and adjust the concentration of VOCs or odor compounds in the desorbate gas at the desorbate gas outlet to 50% of the lower explosive limit.

7. A system for removing VOCs and odor bearing compounds from a contaminated airstream comprising:
(a) an adsorber vessel having a contaminated air inlet and a clean air outlet defining therebetween a generally upwardly directed airflow path through the adsorber vessel, and an adsorbent media input and an adsorb media output defining therebetween a generally downward directed media flow path, said media flow path arranged generally counter to the generally upward directed airflow path;
(b) a desorber having an adsorbent media input and an adsorbent media output defining a generally downward media path therebetween and a desorbate gas inlet and a desorbate gas outlet defining therebetween a generally upward directed desorbate gas flow path, said desorbate gas flow path arranged generally counter to the downward directed media path;
(c) a plurality of spherical beaded adsorbent media formed of one of activated carbon, synthetic organic material based activated carbon, polymeric material, pyrolytic synthetic material, zeolite, silica, or a combination of one or more of these materials;
(d) providing a transport system for transporting said adsorbent media from the media output of the desorber to the media input of the adsorber, and transferring said adsorbent media from the media output of the adsorber to the media input of the desorber;
(e) a lower explosive limit monitor positioned to received the desorbate gas stream leaving the desorber for detecting the concentration of VOCs or odor bearing compounds therein; and
(f) a process logic controller connected to said lower explosive limit monitor and to said transport system for adjusting the transfer rate of the media to maintain a concentration in the desorbate gas of 50% of the lower explosive limit.

8. The system of claim 7 including a hot gas fan for delivering heated ambient air as stripping gas to the desorber gas inlet of the desorber for contacting saturated media in the desorber and exiting the desorber desorbate gas outlet.

9. The system of claim 8 including a heat exchanger for heating ambient air for supplying the hot gas fan and wherein the heat exchanger receives desorbate gas from the desorber for exchanging heat therein to ambient air being supplied to the hot gas fan.

10. The system of claim 8 wherein said hot gas fan is provided with a variable frequency drive to vary the speed of the fan and wherein the fan and variable speed drive are connected to the process logic controller for receiving signals therefrom to adjust the speed of the fan to thereby increase the volume of stripping gas delivered to the desorber to maintain a concentration in the desorbate gas at the desorber gas outlet of 50% of the lower explosive limit.

11. The system of claim 9 including an ambient air intake damper for controlling the quantity of ambient air, to be mixed with exhaust air from the heat exchanger and to be delivered to the hot gas fan and wherein said ambient air intake damper is connected to the process logic controller to thereby modify the volume of ambient air to be mixed with the exhaust air from the heat exchanger to be supplied to the hot gas fan to maintain a concentration in the desorbate gas of 50% of its lower explosive limit.
